(19) United States
(12) Patent Application Publication
(10) Pub. No.: US 2007/0166012 A1
(43) Pub. Date: Jul. 19, 2007

(54) Image data recording method and image data recording apparatus

(76) Inventor: Ryuji Hirata, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/653,823

(22) Filed: Jan. 16, 2007

(30) Foreign Application Priority Data
Jan. 18, 2006 (JP) 2006-010396
Jan. 18, 2006 (JP) 2006-010397
Jan. 18, 2006 (JP) 2006-010398
Jan. 18, 2006 (JP) 2006-010399

(51) Int. Cl. H04N 5/91

(52) U.S. Cl. 386/107

(57) ABSTRACT

Upon copying or moving an image file assigned a file name and containing image data and at least either a shooting date and time related to the image data or exposure related information at the time of shooting to record the image file onto recording means, the file name of the image file to be to be recorded at present is compared with file names of image files already recorded on the recording means. As a result of comparison, when there is no image file having the same file name, the image file to be recorded at present is recorded, or when there is an image file having the same file name, two image files are compared in terms of at least either the shooting date and time or the exposure related information at the time of shooting. Then, as a result of comparison, when the shooting date and time or the exposure related information at the time of shooting is the same between the two image files, the image file to be recorded at present is not recorded, while when the shooting date and time or the exposure related information at the time of shooting is different between the two image files, at least either of the file names of the two image files is changed and the image file to be recorded at present is recorded on the recording means.

### CROSS-REFERENCE TO RELATED APPLICATION

This application is based upon and claims the benefit of priority from prior Japanese Patent Application Nos. 2006-10396, 2006-10397, 2006-10398, and 2006-10399, filed on Jan. 18, 2006, the entire contents of which are incorporated herein by reference.

### BACKGROUND OF THE INVENTION

1. Field of the Invention

The present invention relates to an image data recording method and image data recording apparatus for recording, as image files, photos of subjects taken with a digital camera(s), and collectively managing the recorded image files by uploading them to a personal computer or the like.

2. Description of the Related Art

Images data shot with digital cameras are typically converted into JPEG format and recorded on a recording medium or the like as image files. The DCF standard specifies rules for ensuring image file compatibility among digital cameras of different manufacturers and the EXIF standard specifies rules for recording shooting-related information, such as the shutter speed or shooting date and time data, while ensuring information compatibility. Therefore, data interchangeability is ensured by these standards even if photos are taken with a digital camera of any manufacturer, facilitating user convenience.

For example, Japanese Patent Application Laid-Open No. 10-177646 discloses a file name management method in which during shooting with an electronic camera(s), even if recording media are changed, the creation of file names is not reset as long as shooting is continued with the same electronic camera, so that consecutive file numbers are assigned across the different recording media, thereby preventing co-existence of, two or more files having the same name.

During shooting with a digital camera, shot images are recorded as image files on a recording medium loaded or built in the digital camera. At this time, in order to ensure the compatibility of image files, a recording format and the like are typically prescribed pursuant to each of the above-mentioned standards. A file name is automatically assigned to each image file, but the details of a file name deciding method vary from manufacturer to manufacture.

For example, a product (digital camera) of manufacturer A assigns file names starting from DSCP0001, incrementing the number part by one from the second file name, like DSCP0002, DSCP0003 . . . . Similarly, a product of manufacturer B assigns file names starting from KIMG0001, incrementing the number part by one like KIMG0002, KIMG0003 . . . . Further, a product of manufacturer C assigns file names starting from G1125001, which is followed by G1125002 . . . in a like manner, except that the first four digits “1125” represent the shooting date. In this case, date information is acquired at the time of shooting from clock means built in the digital camera, and the file name is decided based on the date information. The last three digits represent a number part independent of the date, starting from “001” and followed by “002”, “003” . . . . For example, suppose that the first and second frames are shot on November 25 and the third frame is shot on November 26. In this case, respective file names are G1125001, G1125002, and G1126003.

In the examples of manufacturer A and manufacturer B, since four digits are assigned to the number part of each file name, the same file name will never appear unless the number of image files exceeds 10,000. On the other hand, in case of manufacturer C, since only three digits are assigned to the number part of each file name, different image files with the same number can appear if the number of image files exceeds 1,000. However, in this case, since the file name is decided in combination with date data, there is a very low possibility that the same file names will co-exist.

In general, a recording medium removably loaded into a digital camera is used to store shot images on the digital camera. The recording capacity of a recording medium is not infinite, and it is generally assumed that when a recording medium runs out of recording capacity during shooting, it is replaced with a new recording medium on the spot to continue shooting. Upon changing the recording media, if number information to be assigned to the number part at the time of creation of an image file name is reset, the file name of the first image on the new recording medium is always the same name, for example, DSCP0001 in case of manufacturer A.

In such a case, when shot image data recorded on a plurality of recording media are moved or copied to a personal computer for collective management, image files having the file name DSCP0001 exist as many as the number of recording media. If a plurality of image files having the same image file name exist, the personal computer recognizes them as the same image files and overwrites one file with another, causing disadvantageous results.

In order to prevent unwanted overwriting, a folder can be provided and managed for each recording medium without problems. However, when a recording medium runs out of recording capacity during shooting and is replaced with another recording medium to continue shooting, since images recorded separately on a plurality of recording media are often a series of shot images related to one another in an actual shooting situation, storing these images separately in different folders on the personal computer does not fit with the actual shooting situation. For example, if all related images are recorded in a single folder, they can be displayed on one display screen in the form of a list, while if they are recorded separately in different folders, they cannot be displayed at a time even through a series of shot images, causing great inconvenience in performing playback display.

As a method of avoiding this inconvenience, the aforementioned Japanese Patent Application Laid-Open No. 10-177646 teaches that basic information for creating a file name is not reset so that serial numbers (numbers in consecutive order) are assigned across different recording media even if a recording medium is replaced with another during shooting with an electronic camera as long as shooting is continued with the same electronic camera. Use of this method can dramatically reduce the frequency of coexistence of image files having the same number part. For example, in the above-mentioned examples of manufacturer A and manufacturer B, since four digits are assigned to the number part, different image files with the same file name will never appear unless the number of image files exceeds 10,000, so that practical problems can be solved by this method.

However, this method is effective just for a user owning a single digital camera, and may not effectively function for a user owning two or more digital cameras. For example, it is common that a user goes photographing with both a single-lens reflex type digital camera and a compact type digital camera to take photos using both as appropriate.

As mentioned above, the rules of assigning image file names are different from manufacturer to manufacturer. The rules of creating image files are typically standardized across digital cameras made by the same manufacturer, such as between single-lens reflex digital cameras and compact digital cameras or between latest models and old models. In view of the circumstances that a change in the rules of creating image file names without reason or necessity not only can create confusion for users, but also should be avoided from the standpoint of software design of digital cameras, there is a situation where the rules of assigning image file names are less likely to be changed.

However, in the case that a single-lens reflex digital camera and a compact digital camera follow the same rules of creating image file names, if a user takes photos using both cameras concurrently, for example, using those digital cameras made by manufacturer A, both the single-lens reflex type digital camera and the compact type digital camera start from the first image file name DSCP0001 immediately after purchase or in case of using factory default settings. It means that image files with the same file name co-exist.

Further, as described in the above Japanese Patent Application Laid-Open No. 10-177646, if a digital camera is configured to assign serial numbers to image file names even across recording media replaced one with another, the digital camera creates file names while holding therein information indicating which serial number has been used so far for the number part of the last image file name. However, if the digital camera is left for a certain period of time with a dead battery or without battery, the information is typically volatile and hence is not held. Therefore, after the recharged battery is loaded again or a new battery is loaded into the digital camera, the number information is also reset, and the assignment of file names is started from DSCP0001 again.

Even when a user owns the above-mentioned single-lens reflex digital camera and compact digital camera, this problem will not occur unless both or at least either of the digital cameras is left with a dead battery or without battery. However, since a considerable effort is required to keep the battery from dying, there is a high possibility that the digital camera is left with a dead battery or without battery. In this case, the frequency of coexistence of image files having the same file name is high. Further, as the number of cameras owned by the user increases to three, four . . . , the chance of leaving a digital camera inadvertently with a dead battery or without battery becomes higher.

This problem does not occur between digital cameras made by different manufacturers because the rules of creating image file names are different therebetween. However, the kinds of recording media adopted by respective manufacturers for their products, such as SD Memory Card™, Compact Flash™, xD-Picture Card™, etc., vary from manufacturer to manufacturer. Further, there is no compatibility among such a wide variety of recording media. Therefore, when a user owns two or more digital cameras, the user is more likely to select cameras made by the same manufacturer and using the same type of memory card.

Upon collective management on a personal computer of image files shot with cameras made by the same manufacturer and recorded on memory cards of the same type, if different images shot with different cameras have the same image file name, the personal computer will recognize both image files as the same image and try to overwrite them. However, even though both have the same image file name by chance, they are completely different shot images for the user, and improper overwriting is very inconvenient for the user.

### BRIEF SUMMARY OF THE INVENTION

The present invention has been made in view of the aforementioned problems and a main feature thereof is to provide an image data recording method and image data recording apparatus capable of preventing overwriting even if image files having the same image file name co-exist.

The image data recording method of the present invention comprises the steps of: upon copying or moving an image file assigned a file name and containing image data and at least either a shooting date and time related to the image data or exposure related information at the time of shooting to record the image file onto a recording medium, comparing the file name of the image file to be recorded at present with file names of image files already recorded on the recording medium; and recording the image file when there is no image file having the same file name as a result of comparison, or when there is an image file having the same file name, comparing the two image files having the same file name in terms of at least either the shooting date and time or the exposure related information at the time of shooting, and as a result of the comparison, when the shooting date and time or the exposure related information at the time of shooting is the same between the two image files, the image file to be recorded at present is not recorded, while when the shooting date and time or the exposure related information at the time of shooting is different between the two image files, at least either of the file names of the two image files is changed and the image file to be recorded at present is recorded on the recording medium.

This method can be configured as an apparatus.

The image data recording method of the present invention can also be configured to comprise the steps of: upon copying or moving an image file having image data and assigned a file name to record the image file onto a recording medium, comparing the file name of the image file to be recorded at present with file names of image files already recorded on the recording medium; and recording the image file when there is no image file having the same file name as a result of comparison, or when there is an image file having the same file name, comparing the two image files having the same file name in terms of data volume or individual image information representing one piece of image data, and as a result of the comparison, when the data volume or the individual image information is the same between the two image files, the image file to be recorded at present is not recorded, while when the data volume or the individual image information is different between the two image files, at least either of the file names of the two image files is changed and the image file to be recorded at present is recorded on the recording medium.

This method can be configured as an apparatus.

The image data recording method of the present invention can further be configured to comprise the steps of: upon moving or copying an image file created on a camera onto a recording medium, the camera having ID information capable of identifying the model of the camera or an ID different from camera to camera and creating an image file having a file name and containing image data created based on an acquired subject image and the ID information, comparing the file name of the image file to be recorded at present with file names of image files already recorded on the recording medium; and recording the image file when there is no image file having the same file name as a result of comparison, or when there is an image file having the same file name, comparing two image files having the same file name in terms of the ID information, and as a result of comparison, when the ID information is the same between the two image files, the image file to be recorded at present is not recorded, while when the ID information is different between the two image files, at least either of the file names of the two image files is changed and the image file to be recorded at present is recorded on the recording medium.

This method can be not only configured as an apparatus, but also implemented as a camera system.

The image data recording method of the present invention can further be configured to comprise the steps of: acquiring an image file, which is assigned a file name and has an image data recording area for recording image data and image-related information recording area for recording at least either a shooting date and time related to the image data or exposure related information at the time of shooting; creating a new file name for which the file name of the acquired image file is changed; and changing the file name of the acquired image file to the new file name while recording the file name before being changed in the image-related information recording area of the image file and recording the image file on a recording medium.

This method can be configured as an apparatus.

According to the present invention, even if at least two image files have the same file name, it is determined whether the image files have the same image data content using image data-related information. Then, if they are not identical, at least either of the file names of the image files is changed and the image file to be recorded at present is recorded, so that the image files having the same file name but different image data contents are prevented from overwriting each other inadvertently.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a view showing a camera system according to a preferred embodiment of the present invention;

FIG. 2A is a view showing a structure of data recorded on a memory card of a digital camera;

FIG. 2B is a view showing another structure of data recorded on another memory card of another digital camera;

FIG. 2C is a view showing still another structure of data recorded on still another memory card of still another digital camera;

FIG. 3 is a view showing the data structure of an image file;

FIG. 4 is a block diagram of the main part of a digital camera;

FIG. 5 is a block diagram of a personal computer;

FIG. 6 is a flowchart of operation for sequential uploading of image data from memory cards to a personal computer; and

FIG. 7 is a view showing a display screen on the personal computer;

FIG. 8 is a flowchart of operation for sequential uploading of image data from memory cards to a personal computer;

FIG. 9 is a block diagram of the main part of a digital camera; and

FIG. 10 is a flowchart of operation for sequential uploading of image data from memory cards to a personal computer.

### DETAILED DESCRIPTION OF THE PREFERRED EMBODIMENTS

A preferred embodiment of the invention is described in detail below with reference to the accompanying drawings.

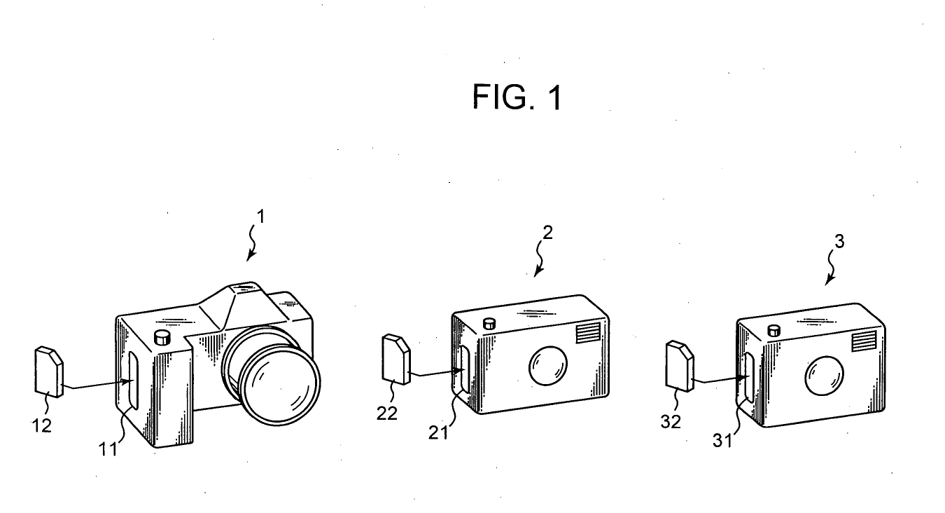

FIG. 1 is a view showing a camera system according to a preferred embodiment of the present invention. The camera system according to the embodiment of the present invention is comprised of three digital cameras, namely a single-lens reflex type digital camera 1 and compact type digital cameras 2, 3.

Here, it is assumed that the digital cameras 2 and 3 are the same model, and all the digital cameras 1, 2, and 3 are made by manufacturer A. In other words, the assignment of file names to image files is started from DSCP0001 as stated above in all the digital cameras 1, 2, and 3, and the number part of the file name is increased to DSCP0002, DSCP0003 . . . each time an image is shot and recorded. The digital cameras 1, 2, and 3 have memory card slots 11, 21, and 31 capable of removably loading recording media, respectively, and memory cards 12, 22, and 32 as recording media are loaded into corresponding memory card slots 11, 21, and 31, respectively.

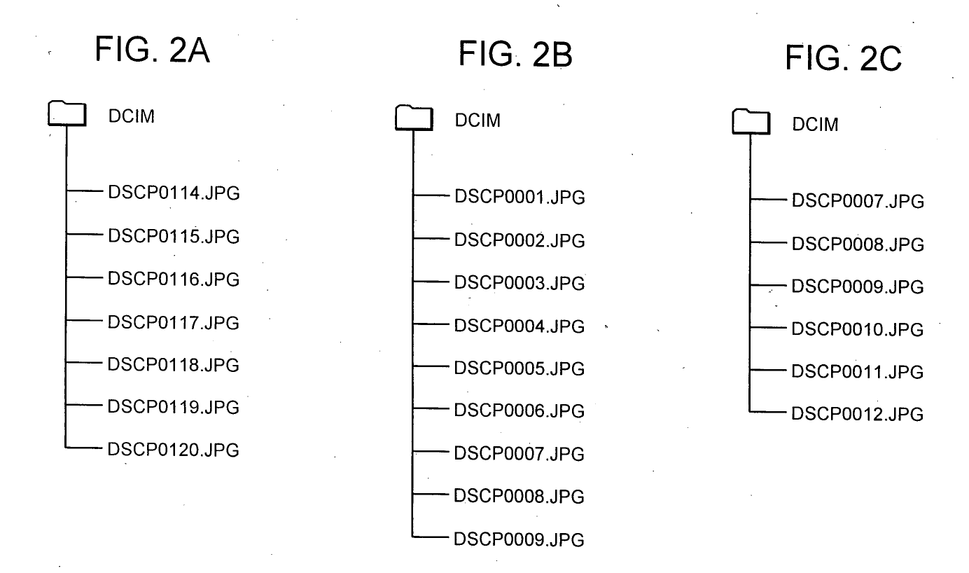

FIGS. 2A, 2B, and 2C show data structures of image file data shot with the digital cameras 1, 2, 3 and recorded on the memory card 12, 22, 32, respectively. As shown, a plurality of image files are recorded in a line below a folder named CDIM in a tree structure.

As shown in FIG. 2A, there are seven image files DSCP0114 to DSCP0120 containing image data shot with the digital camera 1 and recorded on the memory card 12 as the image files. Similarly, as shown in FIG. 2B, there are nine image files DSCP0001 to DSCP0009 containing image data shot with the digital camera 2 and recorded on the memory card 22 as the image files. Further, as shown in FIG. 2C, there are six image files DSCP0007 to DSCP0012 containing image data shot with the digital camera 3 and recorded on the memory card 32 as the image files. In other words, a total of 22 image files containing image data shot with the three digital cameras are recorded in a distributed manner on a total of three memory cards 12, 22, and 32 loaded in the digital cameras 1, 2, and 3, respectively.

Here, the assignment of file names on the digital camera 1 is started from DSCP0114 and there are no file names DSCP0001 to DSCP0113, each having a lower number in its number part than DSCP0114. It means either that corresponding image files have already been moved or erased and hence the image files themselves are not left on the memory card 12, or that the image files DSCP0001 to DSCP0113 have been already recorded on a memory card loaded immediately before the memory card concerned is newly loaded into the digital camera 1. The digital camera 1, 2, and 3 are assumed to have such a function not to reset the starting file name as described in Japanese Patent Application Laid-Open No. 10-177646 mentioned above as related art of the present invention, but this function is not necessarily indispensable feature of the present invention.

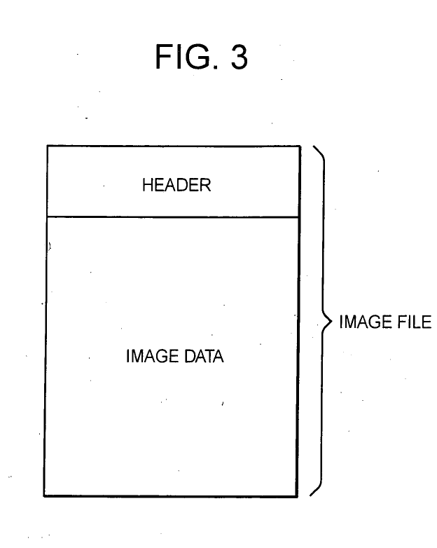

FIG. 3 shows the data structure of an image file. The image file has a header part and an image data part. In the image data part, image information as one piece of image data corresponding to one shot image is stored, while in the header part, various kinds of information related to the image data are stored. The various kinds of information typically include its file name and EXIF data, but it can also target various other kinds of information, such as a classification code related to the image data, history information on the image data, ID information, print-related information, etc.

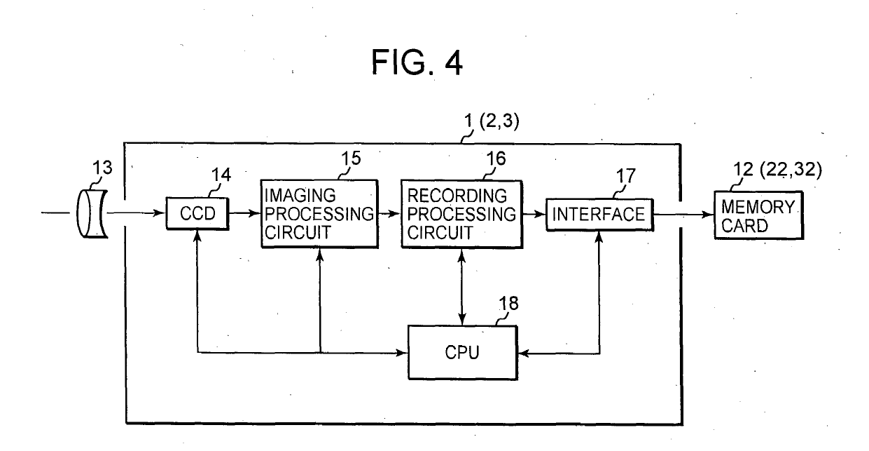

FIG. 4 illustrates a block diagram of the main part of the digital camera 1. As shown in FIG. 4, a subject image acquired through a photographing lens 13 is formed on a CCD 14, and the formed subject image is photoelectrically converted and subjected to necessary imaging processing in an imaging processing circuit 15. Further, the subject image is converted in a recording processing circuit 16 into an image file format, for example, JPEG format, and recorded on the memory card 12 through an interface 17. The CCD 14, the imaging processing circuit 15, the recording processing circuit 16, and the interface 17 are centrally controlled by a central processing circuit (CPU) 18. The digital cameras 2 and 3 also have substantially the same block structure.

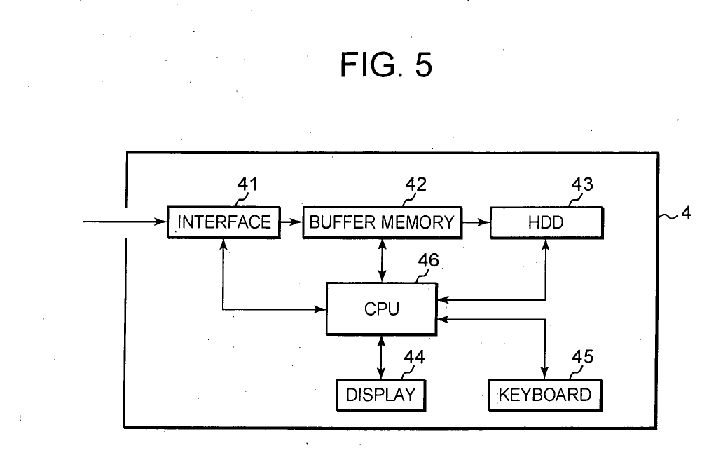

FIG. 5 illustrates a block diagram of the main part of a personal computer 4. As shown in FIG. 5, an interface 41 for acquiring image files is provided in the personal computer 4. The interface corresponds to a card slot or a USB connector provided in the personal computer, or it can be a memory card slot. Provided further in the personal computer 4 are a buffer memory 42 for temporary storage of the image files acquired through the interface 41, an internal hard disk drive (HDD) 43 as large-capacity recording means, a display 44 such as an LCD for displaying the content of image data and/or providing information to a user, and a keyboard 45 as command input means. These components are centrally controlled by a central processing circuit (CPU) 46.

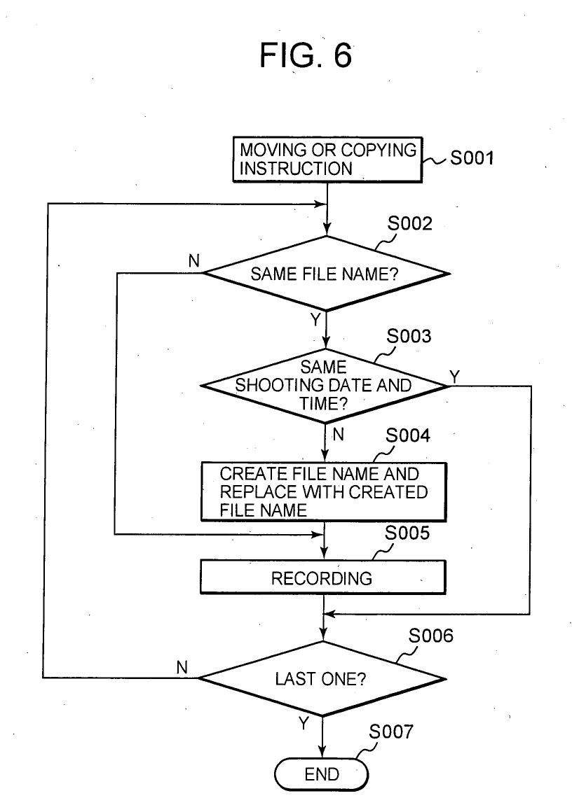

FIG. 6 illustrates a flowchart of operation for sequential uploading of image data from recording media (memory cards) of digital cameras to a personal computer. The following describes, along the flowchart of FIG. 6, a procedure for sequential uploading of image files from the memory cards to the personal computer and management of the image files performed on the personal computer in an integrated fashion.

First, the image files on the memory card 12 of the digital camera 1 are moved or copied to the personal computer 4. Upon moving or copying, a USB memory like adapter device having a memory card slot part and a USB connector part can be used, or a computer card adapter having a memory card slot therein and formed into a shape capable of being inserted into a card slot provided in the personal computer can be used instead. If the digital camera has a USB connection terminal, the digital camera can be directly connected to a USB terminal of the personal computer through a USB cable. In this case, the upload configuration is selected from among various kinds of well-known means. The uploaded image files can be recorded either inside the personal computer or in any one of storage devices such as an external hard disk unit connected to the personal computer. Here, it is assumed that the captured image files are recorded inside the personal computer.

First, in step S001, an instruction is input through the keyboard 45 to move or copy image files on the memory card 12 of the digital camera 1. In case of the digital camera 1, moving or copying of the seven image files DSCP0114 to DSCP0120 is instructed. As a result, the image files are transferred one by one into the buffer memory 42, and in step S002, each image file name is checked to determine whether image files having the same file name exist. This determination is made by the CPU 46 checking image files already recorded on the HDD 43. If there is no image file recorded inside the personal computer, that is, on the HDD 43, since it means that there is no image file having a file name overlapping with that of the image file to be recorded, “N” is determined in step S002, and the procedure jumps to step S005 in which the image file DSCP0114 is moved from the buffer memory 42 and recorded on the HDD 43. If the recording is performed for the first time, a folder is newly created for the image file and the image file is recorded in the folder. This folder can be created by the user beforehand or the personal computer can automatically created in response to the input of the instruction in step S001 to copy or move the image files.

After completion of recording the image file in step S005, it is then determined in step S006 whether the image file is the last one to be moved or copied. If it is the last one (if “Y” in step S006), the procedure proceed to step S007 to end the operation. If it is not the last one (if “N” in step S006), the procedure returns to step S002 again to repeat the above-mentioned sequence of operation steps. In case of the digital camera 1, since the image files DSCP0115 to DSCP0120 follow the image file DSCP0114, the above-mentioned sequence of operation steps is repeated until all the seven image files are recorded.

Next, the image files on the memory card 22 of the second digital camera 2 are moved or copied in the same manner. Since this procedure is to manage image files on the personal computer 4 in an integrated fashion, the image files on the memory card 22 are, of course, recorded in the folder in which the image files DSCP0114 to DSCP0120 have already been recorded. Up to this time, the seven image files DSCP0114 to DSCP0120 have already been moved or copied from the memory card 12 and recorded inside the personal computer 4. However, since there are no overlapping file-names with those of the image files DSCP0001 to DSCP0009 newly moved or copied from the memory card 22, the nine image files having the file names DSCP0001 to DSCP0009 are added intact and recorded in response to the moving or copying instruction via the procedure steps S001, S002, S005, S006, and S007. Upon completion of the recording, the total number of recorded image files is 16.

After that, the six image files on the memory card 32 of the third digital camera 3 are moved or copied to the personal computer 4 in the same manner as mentioned above. Up to this time, a total of 16 image files, that is, DCSP0114 to DSCP0120 and DSCP0001 to DSCP0009 have already been recorded inside the personal computer 4. In this case, the file names DSCP0007 to DSC0009 partially overlap with those of the image files DSCP0007 to DSCP0012 to be newly moved or copied from the memory card 32. Therefore, if moving or copying of image files is instructed in step S001, each image file name is checked in step S002 to determine the presence or absence of image files having the same file name. In this case, when the image files DSCP0007 to DSCP0009 are checked, “Y” is determined in step S002.

If there are image files having the same file name and “Y” is determined in step S002, EXIF data of the two corresponding image files are referred to in step S003 to acquire and compare respective shooting date and time data. In the EXIF standard, a specification for recording the shooting date and time of image data is specified and actually used by camera manufacturers. Therefore, the shooting date and time data, that is, data on the date and time at which each image was shot is acquired here.

As a result of comparison, if they are the same shooting date and time, the image files are determined to contain the same image data (that is, “Y” is determined). If they are the same image data, since the image data is already recorded inside the personal computer 4, the moving or copying operation of the image file is skipped, and the procedure proceeds to step S006. In step S006, it is determined whether the image file concerned is the last one to be moved or copied. If it is the last one (“Y” in step S006), the procedure proceeds to step S007 to end the operation, while if it is not the last one (“N” in step S006), the procedure returns to step S002 again to repeat the sequence of operation steps.

On the other hand, as a result of comparison in step S003, if the shooting date and time data are not identical (“N” in step S003), it is determined that the image files are different image data even though they have the same image file name and hence should not be overwritten. After that, a new image file name is created in step S004. In the embodiment, image files having file names DSCP0007 to DSCP0009 are overlapping. As for DSCP0007 recorded on the memory card 32, a new file name, for example, DSCP0007A is created to make it distinguishable from DSCP0007 already existing. Then, the previous file name DSCP0067 is replaced with the created new file name DSCP0007A, and recorded as an image file having the new file name DSCP0007A. In other words, in this case, both image files DSCP0007 and DSCP0007A are recorded inside the personal computer 4. The same processing is performed on DSCP0008 and DSCP0009, and finally a total of 22 image files DSCP0001 to DSCP0012, DSCP0007A to DSCP0009A, and DSCP0114 to DSCP0120 are recorded inside the personal computer 4.

Upon creation of and replacement with the image file name DSCP0007A, DSCP0007 previously assigned to the image file as its original file name can be recorded in the image file, or in an optional recording area specified in EXIF. The recording location is, of course, not limited to that in EXIF, and it can be the header area of the image file. Thus, since the original file name assigned at the time of shooting is recorded, this information can be used any time to replace the file name with the original file name assigned at the time of shooting and hence to make the original file name restorable. This makes editing easy. For example, after completion of the above-mentioned processing, if the user wants to manage only the image files containing the images shot with the digital camera from a totally different perspective, the replaced file names of the image files can be restored to their original file names to enable sorting of the image files in an on-target manner such as to sort the image files in order of file name. This is useful in editing later. Of course, the file names used immediately before the second replacement, for example, the file name DSCP0007A, can further be recorded.

In the embodiment, although the shooting date and time information is used to compare image files, the information to be compared is not limited to the shooting date and time information. For example, information related to exposure (exposure related information, such as the shutter speed value and aperture value, specified in the EXIF standard and is in practical use can also be used. Further, these pieces of information can be used in combination. For example, use of a combination of the shooting date and time and the shutter speed value to compare image files enables more accurate determination. If the aperture value is further added to compare image files, it can be determined further more accurately whether image data contained in the image files are identical or not. The information to be compared can further include other various and available data adopted in the EXIF standard such as, for example, color temperature information, panorama information, auto bracketing information, etc.

Each operation step of moving or copying image data described in FIG. 6 is performed by starting software exclusive for image management. This software will be described below.

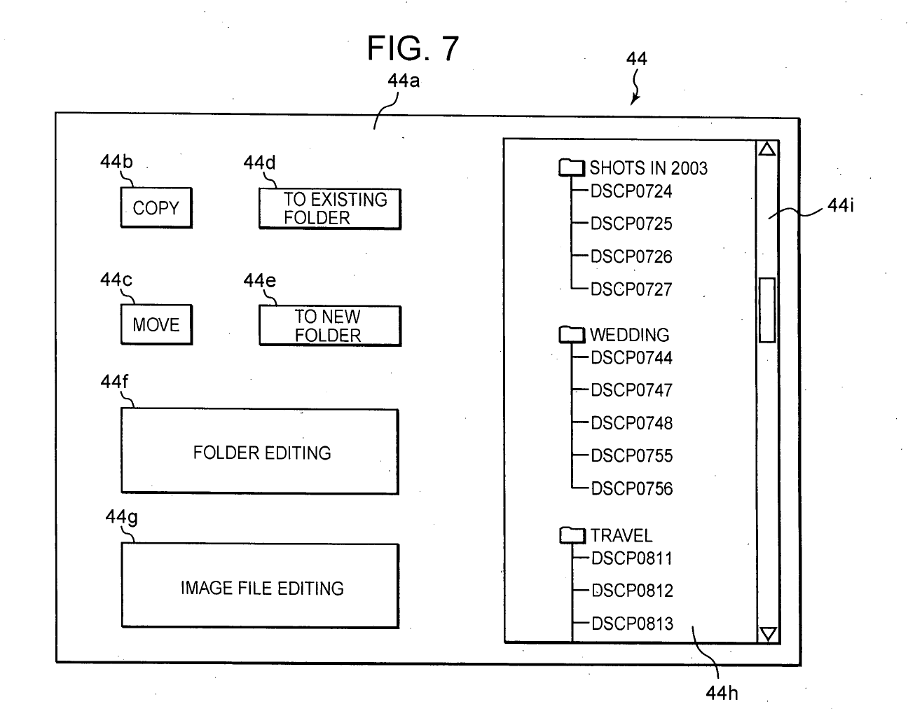

When the software for image management is started after boot-up of the personal computer 4, a display screen as shown in FIG. 7 appears on the display 44. FIG. 7 shows a display state on the personal computer, indicating that some folders are already created in the past and a plurality of image file are recorded in each folder, respectively. For example, as shown in FIG. 7, folders can be classified by shooting year such as for image files shot in 2003, for image files shot in 2004, etc., or by event such as travel, wedding, etc. In any case, the user can not only create folders at the user's discretion, but also move an image file to another folder, edit an image file, etc.

As shown in FIG. 7, a plurality of operation instructing areas 44b to 44g and a display area 44h for displaying the tree structure of recorded image files are arranged in a display screen 44a on the display 44. Reference numerals 44b and 44c designate switches to let the user select whether to copy or move an image file input from the interface 41. If COPY is selected, the original data of the image file is left intact on the original recording medium, while if MOVE is selected, the original data is deleted from the original recording medium. Reference numerals 44d and 44e designate switches to let the user select a destination folder to which the image file is moved or copied. If the switch 44d is selected, a step of selecting to which folder the image file is moved or copied follows. In the embodiment, though not shown in detail in FIG. 7, this step is performed by selecting a desired folder in the display area 44h on the right side of the screen 44a using a mouse or the keyboard and clicking thereon. On the other hand, if the switch 44e is selected, a new folder is automatically created and the image file is moved or copied to the new folder.

Reference numeral 44f designates a folder editing switch. If this switch is selected, the user is allowed in sequential steps to delete a folder, change a folder name, etc., though the details of which are omitted here. Reference numeral 44g designates an image file editing switch. If this switch is selected, the user is allowed in sequential steps to move an image file to another folder, delete the image file, replace the file name again with that before replaced therewith, etc., though the details of which are omitted here.

The display area 44h is an area for displaying the data structure. In the display area 44h, folders and image files recorded in respective folders are displayed in a tree structure. The image files are listed under each folder. A scroll bar 44i appears on the right-end side of the display area 44h, allowing the user to scroll the list and see the area in the tree structure that cannot be displayed at a time. Each of the operation steps in the flowchart shown in FIG. 6 is performed by operating these switches 44b to 44g in combination with the keyboard 45. Note that the switches 44b to 44g are to be displayed on the display 44 of the personal computer 4, and their selection operations are achieved by selecting a desired item using the mouse, not shown, or the keyboard 45 and clicking thereon.

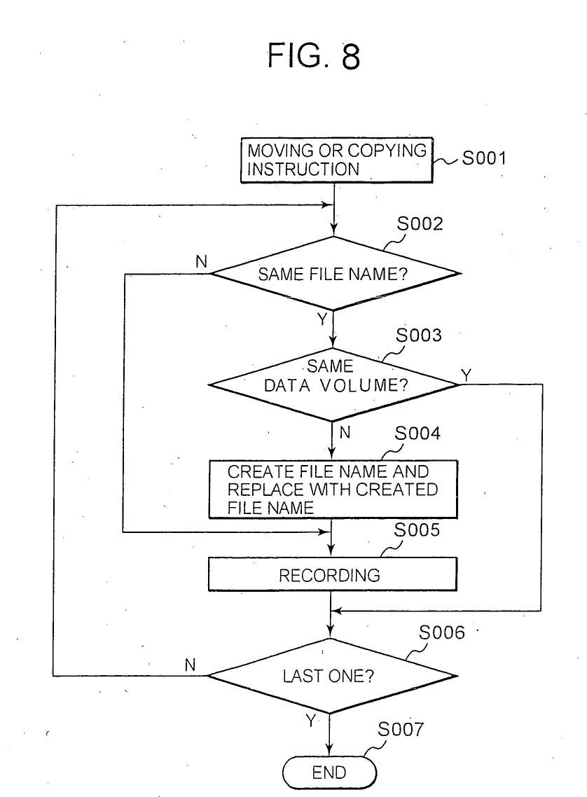

Example 2 of the present invention will be described in detail below. In Example 2, the step S003 is only different from the flowchart shown in FIG. 6 as described in the above embodiment, and other steps are same. Details of the differed part will be described below with reference FIG. 8.

If there are image files having the same file name and “Y” is determined in step S002, data volume of the two corresponding image files are referred to in step S003 to acquire and compare respective data volume. Data volume is varied depends on image pixel number, that is the size of the image, compressing ratio and the recorded content of the image. For example, as same image pixel number and compression ratio, in the condition of the uniform of the brightness or color distribution in the image, the data volume of the image decrease, in the condition of wide distribution of the brightness or color distribution in the image, the data volume of the image increase. This embodiment aims that the probability of the data volume being the same as the compared two image files is very few, and use it for determine whether the image files contain the same image data. As a result of comparison, if they are the same data volume, the image files are determined to contain the same image data (that is, “Y” is determined). If they are the same image data, since the image data is already recorded inside the personal computer 4, the moving or copying operation of the image file is skipped, and the procedure proceeds to step S006. In step S006, it is determined whether the image file concerned is the last one to be moved or copied. If it is the last one (“Y” in step S006), the procedure proceeds to step S007 to end the operation, while if it is not the last one (“N” in step S006), the procedure returns to step S002 again to repeat the sequence of operation steps.

On the other hand, as a result of comparison in step S003, if the data volume are not identical (“N” in step S003), it is determined that the image files are different image data even though they have the same image file name and hence should not be overwritten. After that, a new image file name is created in step S004. In the embodiment, image files having file names DSCP0007 to DSCP0009 are overlapping. As for DSCP0007 recorded on the memory card 32, a new file name, for example, DSCP0007A is created to make it distinguishable from DSCP0007 already existing. Then, the previous file name DSCP0007 is replaced with the created new file name DSCP0007A, and recorded as an image file having the new file name DSCP0007A. In other words, in this case, both image files DSCP0007 and DSCP0007A are recorded inside the personal computer 4. The same processing is performed on DSCP0008 and DSCP0009, and finally a total of 22 image files DSCP0001 to DSCP0012, DSCP0007A to DSCP0009A, and DSCP0114 to DSCP0120 are recorded inside the personal computer 4.

In the embodiment, although the data volume is used to compare image files, the information to be compared is not limited to the data volume. Since it determine whether the content of the image is the same, image information itself may be compared. In the each image information corresponding pixel data of the recorded data as the digital data, it may be used a part of the data by sampling. It may be used a head part of the data. It may be used a whole pixel data, however it needs long time, it is efficient to compare a part of the data, and the determination can be done more quickly. The comparison is made by calculating the difference regarding each image information, and the result of the calculation is zero, it determined that the two image data are the same image data. The image data itself and the image data volume were made naturally with making image data. For example, like a information regulated by EXIF standard as standardized among many camera makers, it can compare the data taken from the data made by the makers observe the standard. However, it is impossible to compare the data taken from the data made by the makers do not observe the standard. Further, if standardize is imperfect, it can not compare the data. On the other hand, as this invention, by using image data or individual image information made naturally with image data making, it can be compared more universally and it is useful.

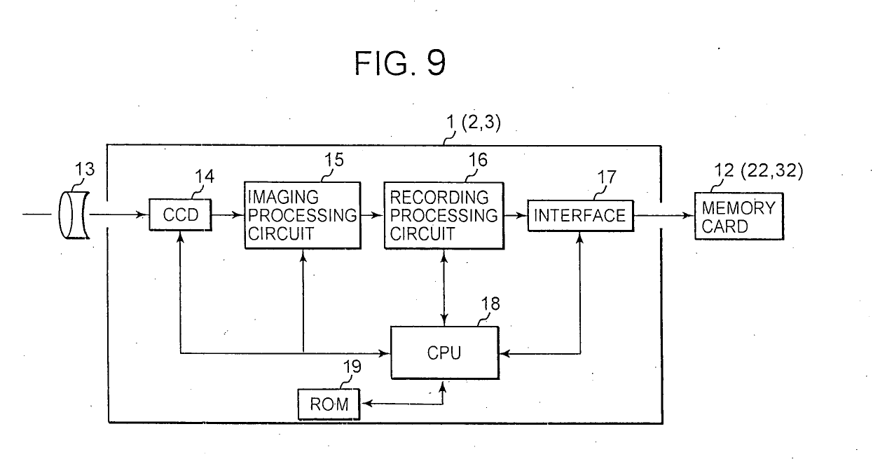

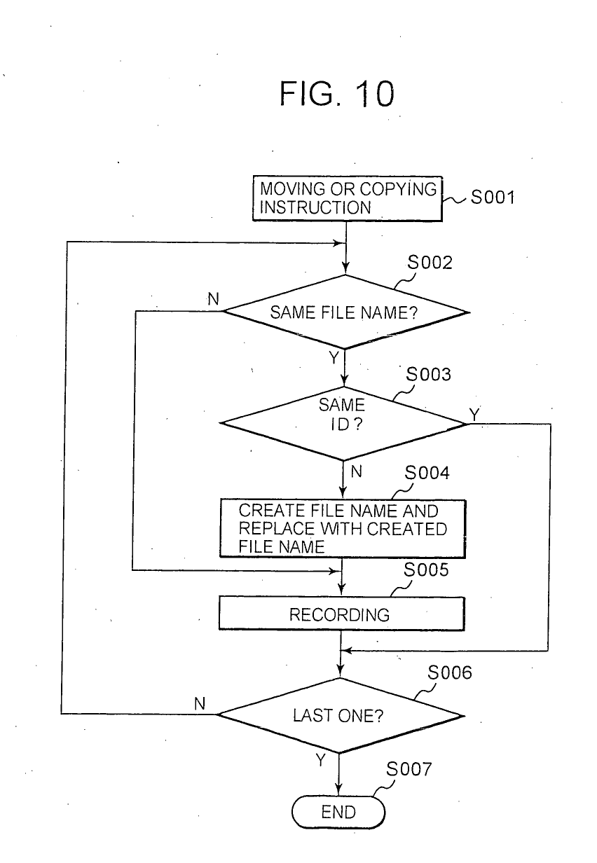

Example 3 of the present invention will be described in detail below. In Example 3, ID information being ready in the camera is different from above described embodiment and the step S003 is only different from the flowchart shown in FIG. 6 as described in the above embodiment. But, other is same. Details of the differed part will be described below with reference FIGS. 9 and 10.

FIG. 9 illustrates a block diagram of the main part of the digital camera 1. As shown in FIG. 9, a subject image acquired through a photographing lens 13 is formed on a CCD 14, and the formed subject image is photoelectrically converted and subjected to necessary imaging processing in an imaging processing circuit 15. Further, the subject image is converted in a recording processing circuit 16 into an image file format, for example, JPEG format, and recorded on the memory card 12 through an interface 17. The CCD 14, the imaging processing circuit 15, the recording processing circuit 16, and the interface 17 are centrally controlled by a central processing circuit (CPU) 18. A ROM 19 which hold an ID information which can discriminate digital camera is connected to the CPU 18, and the ID information was recorded in the ROM at the shipment. In the ROM 19, for example, “S4 DB4641” is recorded as the ID information. In this information, “S4” is an ID information part represent the camera model. This ID information is recorded additionally in the image file recorded in the memory card 12. For example, the ID information is recorded in the header part of the image file. It can be recorded in the known EXIF information recording area. The digital cameras 2 and 3 also have substantially the same structure. “C2AE3019” is recorded in the ROM 19 in the digital camera 2 and “C2AE3017” is recorded in the ROM 19 in the digital camera 3 as the ID information respectively. Since the digital cameras 2 and 3 are same model, “C2” which represent camera model in the ID information are the same.

If there are image files having the same file name and “Y” is determined in step S002, camera ID information of the two corresponding image files are referred to in step S003 to acquire and compare respective camera ID information. As a result of comparison, if they are the same camera ID information, the image files are determined to contain the same image data (that is, “Y” is determined). If they are the same image data, since the image data is already recorded inside the personal computer 4, the moving or copying operation of the image file is skipped, and the procedure proceeds to step S006. In step S006, it is determined whether the image file concerned is the last one to be moved or copied. If it is the last one (“Y” in step S006), the procedure proceeds to step S007 to end the operation, while if it is not the last one (“N” in step S006), the procedure returns to step S002 again to repeat the sequence of operation steps.

On the other hand, as a result of comparison in step S003, if the ID informations are not identical (“N” in step S003), it is determined that the image files are different image data even though they have the same image file name and hence should not be overwritten. After that, a new image file name is created in step S004. In the embodiment, image files having file names DSCP0007 to DSCP0009 are overlapping. As for DSCP0007 recorded on the memory card 32, a new file name, for example, DSCP0007A is created to make it distinguishable from DSCP0007 already existing. Then, the previous file name DSCP0007 is replaced with the created new file name DSCP0007A, and recorded as an image file having the new file name DSCP0007A. In other words, in this case, both image files DSCP0007 and DSCP00007A are recorded inside the personal computer 4. The same processing is performed on DSCP0008 and DSCP0009, and finally a total of 22 image files DSCP0001 to DSCP0012, DSCP0007A to DSCP0009A, and DSCP0114 to DSCP0120 are recorded inside the personal computer 4.

In the embodiment, although the ID information which can discriminate digital camera one by one used to compare image files, the information to be compared is not limited to the shooting date and time information. For example, it can be assumed that many users have single lens reflex type digital camera and compact type digital camera, however, it can be assumed that there are few users who have two same model digital cameras. Therefore, ID information may be the information for discriminate camera model only (not for one by one), in this case, the ID information in digital camera 1 is “S4”, and the ID information in digital cameras 2 and 3 is “C2”. Since the ID information can only discriminate camera model, there is no need to hold the ID information which can discriminate camera one by one, the information held in ROM can be simplified. Further, in the same camera model, the content held in the ROM 19 is same, then ROM can be made with low cost, and it is profitable in production.

In the embodiment, all image files on recording media connected to the interface 41 of the personal computer 4 can be collectively copied or moved at a time, but image files to be copied or moved can also be selected individually.

Further, although the embodiment is described above based on the camera system including the single-lens reflex type digital camera 1 and the compact type digital cameras 2 and 3, all of which are made by manufacturer A, any other combinations of different types or different numbers of digital cameras are, of course, possible in a range without departing from the gist of the present invention. For example, a camera system consisting of a total of five cameras can be considered, in which two cameras of the same model made by manufacturer B are added to the camera system in the embodiment consisting of the three cameras made by manufacturer A. Thus, there are a myriad of variations in the combination and number of digital cameras in the camera system.

In the embodiment, the buffer memory 42 and the hard disk drive 43 function as recording means, and the CPU 46 functions as comparison means and recording control means, respectively, but the present invention is not limited thereto.

The embodiment targets image data shot with a digital camera, but the present invention is also not limited thereto, and the image data can be acquired from any other equipment equivalent in function to the digital camera. For example, a cellular phone with a camera can be used instead of the digital camera, in which data captured with its camera function is recorded on a recording medium and sent to a personal computer using its mail function. In addition, the target image data is not limited to a still image, and it can be a moving picture. For example, the image data can be moving picture data captured using a digital camcorder (digital video camera).

Further, in the embodiment, the image data of the digital camera are collectively stored and managed on the personal computer, but the present invention is not limited thereto, and any other equipment having an equivalent function can be used instead of the personal computer. For example, a card reader having a memory function such as a hard disk or recording medium, a digital camcorder, a DVD recorder/player, or a TV set with a built-in hard disk.

As described, according to the present invention, it is determined using shooting-related information whether image files contain the same image data content even though they have the same image file name, and if they are not identical, the image file name to be recorded is automatically changed and recorded, thereby preventing improper overwriting of image data having the same file name but different image data contents.

While there has been shown and described what is considered to be a preferred embodiment of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. An image data recording method comprising the steps of: upon copying or moving an image file assigned a file name and containing image data and at least either a shooting date and time related to the image data or exposure related information at the time of shooting to record the image file onto a recording medium,
comparing the file name of the image file to be recorded at present with file names of image files already recorded on the recording medium; and
recording the image file to be recorded at present when there is no image file having the same file name as a result of comparison, or when there is an image file having the same file name, comparing two image files having the same file name in terms of at least either the shooting date and time or the exposure related information at the time of shooting, and as a result of comparison, when the shooting date and time or the exposure related information at the time of shooting is the same between the two image files, the image file to be recorded at present is not recorded, while when the shooting date and time or the exposure related information at the time of shooting is different between the two image files, at least either of the file names of the two image files is changed and the image file to be recorded at present is recorded on the recording medium.

2. The image data recording method according to claim 1 wherein when there is an image file having the same file name as a result of the comparison, the two image files having the same file name are compared in terms of both the shooting date and time and the exposure related information at the time of shooting.

3. The image data recording method according to claim 1 wherein upon changing the file name of at least either of the two image files determined to have the same file name and determined to be different in the shooting date and time or the exposure related information at the time of shooting as a result of the comparisons, the file name before being changed is recorded in the image file the file name of which is changed.

4. The image data recording method according to claim 3 wherein when the image file the file name of which is changed is recorded on the recording medium, the file name is made restorable to the file name before changed, and upon restoring the file name of the image file to the file name before changed, the file name that has been changed before being restored is further recorded in the image file.

5. An image data recording method comprising the steps of: upon copying or moving an image file having image data and assigned a file name to record the image file onto a recording medium;
comparing the file name of the image file to be recorded at present with file names of image files already recorded on the recording medium; and
recording the image file when there is no image file having the same file name as a result of comparison, or when there is an image file having the same file name, comparing two image files having the same file name in terms of data volume or individual image information representing one piece of image data, and as a result of comparison, when the data volume or the individual image information is the same between the two image files, the image file to be recorded at present is not recorded, while when the data volume or the individual image information is different between the two image files, at least either of the file names of the two image files is changed and the image file to be recorded at present is recorded on the recording medium.

6. The image data recording method according to claim 5 wherein the individual image information representing one piece of image data to be compared includes part or whole of the one piece of image data.

7. An image data recording method comprising the steps of: upon moving or copying an image file created on a camera onto a recording medium, the camera having ID information capable of identifying the model of the camera and creating the image file having a file name and containing image data created based on an acquired subject image and the ID information;
comparing the file name of the image file to be recorded at present with file names of image files already recorded on the recording medium; and
recording the image file when there is no image file having the same file name as a result of comparison, or when there is an image file having the same file name, comparing two image files having the same file name in terms of the ID information, and as a result of comparison, when the ID information is the same between the two image files, the image file to be recorded at present is not recorded, while when the ID information is different between the two image files, at least either of the file names of the two image files is changed and the image file to be recorded at present is recorded on the recording medium.

8. An image data recording method comprising the steps of: upon moving or copying an image file created on a camera onto a recording medium, the camera having ID information different from camera to camera so that each camera can be identified individually and creating the image file having a file name and containing image data created based on an acquired subject image and the ID information;
comparing the file name of the image file to be recorded at present with file names of image files already recorded on the recording medium; and
recording the image file when there is no image file having the same file name as a result of comparison, or when there is an image file having the same file name, comparing two image files having the same file name in terms of the ID information, and as a result of comparison, when the ID information is the same between the two image files, the image file to be recorded at present is not recorded, while when the ID information is different between the two image files, at least either of the file names of the two image files is changed and the image file to be recorded at present is recorded on the recording medium.

9. An image data recording method comprising the steps of:
acquiring an image file, which is assigned a file name and has an image data recording area for recording image data and image-related information recording area for recording at least either a shooting date and time related to the image data or exposure related information at the time of shooting;
creating a new file name for which the file name of the acquired image file is changed; and
changing the file name of the acquired image file to the new file name while recording the file name before being changed in the image-related information recording area of the image file and recording the image file on a recording medium.

10. The image data recording method according to claim 9 wherein the file name of the image file is restored to the file name before changed, which is recorded in the image-related information recording area, while further recording the file name before being restored in the image-related information recording area.

11. An image data recording apparatus comprising:
a recording medium for recording an image file moved or copied thereto, the image file assigned a file name and containing image data and at least either of a shooting date and time related to the image data and exposure related information at the time of shooting;
a comparison part for comparing the file name of the image file to be recorded at present with file names of image files already recorded on the recording medium; and
a control part which records the image file to be recorded at present when there is no image file having the same file name as a result of comparison by the comparison part, or when there is an image file having the same file name, which compares two image files having the same file name in terms of at least either the shooting date and time or the exposure related information at the time of shooting, and as a result of comparison, when the shooting date and time or the exposure related information at the time of shooting is the same between the two image files, the image file to be recorded at present is not recorded, while when the shooting date and time or the exposure related information at the time of shooting is different between the two image files, at least either of the file names of the two image files is changed and the image file to be recorded at present is recorded on the recording medium.

12. The image data recording apparatus according to claim 11 wherein when there is an image file having the same file name as a result of the comparison by the comparison part, the control part compares the two image files having the same file name in terms of both the shooting date and time and the exposure related information at the time of shooting.

13. The image data recording apparatus according to claim 11 wherein upon changing the file name of at least either of the two image files determined to have the same file name as a result of the comparison by the comparison part and determined to be different in the shooting date and time or the exposure related information at the time of shooting, the control part records the file name before being changed in the image file the file name of which is changed.

14. The image data recording apparatus according to claim 13 wherein when the image file the file name of which is changed is recorded on the recording medium, the control parts makes the file name of the image file restorable to the file name before changed, and upon restoring the file name of the image file to the file name before changed, the file name before being restored is further recorded in the image file.

15. An image data recording apparatus comprising:
a recording medium for recording an image file moved or copied thereto, the image file assigned a file name and containing image data;
a comparison part for comparing a file name of an image file to be recorded at present with file names of image files already recorded on the recording medium; and
a control part for recording the image file to be recorded at present when there is no image file having the same file name as a result of comparison by the comparison part, or when there is an image file having the same file name, which compares two image files having the same file name in terms of data volume or individual image information representing one piece of image data, and as a result of comparison, when the data volume or the individual image information is the same between the two image files, the image file to be recorded at present is not recorded, while when the data volume or the individual image information is different between the two image files, at least either of the file names of the two image files is changed and the image file to be recorded at present is recorded on the recording medium.

16. The image data recording apparatus according to claim 15 wherein the individual image information representing one piece of image data to be compared includes part or whole of the one piece of image data.

17. An image data recording apparatus comprising:
a recording medium for recording an image file moved or copied thereto, the image file created on a camera having ID information capable of identifying the model of the camera and creating the image file having a file name and containing image data created based on an acquired subject image and the ID information;
a comparison part for comparing the file name of the image file to be recorded at present with file names of image files already recorded on the recording medium; and
a control part which records the image file when there is no image file having the same file name as a result of comparison by the comparison part, or when there is an image file having the same file name, which compares two image files having the same file name in terms of the ID information, and as a result of comparison, when the ID information is the same between the two image files, the image file to be recorded at present is not recorded, while when the ID information is different between the two image files, at least either of the file names of the two image files is changed and the image file to be recorded at present is recorded on the recording medium.

18. An image data recording apparatus comprising:
a recording medium for recording an image file moved or copied thereto, the image file created on a camera having ID information different from camera to camera so that each camera can be identified individually and creating the image file having a file name and containing image data created based on an acquired subject image and the ID information;
a comparison part for the file name of the image file to be recorded at present with file names of image files already recorded on the recording medium; and
a control part which records the image file when there is no image file having the same file name as a result of comparison by the comparison part, or when there is an image file having the same file name, which compares two image files having the same file name in terms of the ID information, and as a result of comparison, when the ID information is the same between the two image files, the image file to be recorded at present is not recorded, while when the ID information is different between the two image files, at least either of the file names of the two image files is changed and the image file to be recorded at present is recorded on the recording medium.

19. An image data recording apparatus comprising:
a file name creating part for acquiring an image file, which is assigned a file name and has an image data recording area for recording image data and image-related information recording area for recording at least either a shooting date and time related to the image data or exposure related information at the time of shooting, to create a new file name for which the file name of the acquired image file is changed; and
a control part for changing the file name of the acquired image file to the file name newly created by the file name creating part while recording the file name before being changed in the image-related information recording area of the image file and recording the image file on a recording medium.

20. The image data recording apparatus according to claim 19 wherein the control part restores the file name of the image file to the file name before changed, which is recorded in the image-related information recording area, while further recording the file name before being restored in the image-related information recording area.
